(19) United States
(12) Patent Application Publication
(10) Pub. No.: US 2025/0106338 A1
(43) Pub. Date: Mar. 27, 2025

(54) IMAGE READING DEVICE

(71) Applicant: SEIKO EPSON CORPORATION, Tokyo (JP)

(72) Inventors: Seiji TEZUKA, KITAKYUSHU-SHI (JP); Masaki NAMIKI, KITAKYUSHU-SHI (JP)

(21) Appl. No.: 18/894,142

(22) Filed: Sep. 24, 2024

(30) Foreign Application Priority Data
Sep. 27, 2023 (JP) 2023-164715

(51) Int. Cl. H04N 1/00

(52) U.S. Cl. CPC H04N 1/00909; H04N 1/00814; H04N 2201/0081

(57) ABSTRACT

A reading unit configured to read an image of a medium conveyed in a conveyance direction in a conveyance path, a rotation member disposed to face the reading unit across the conveyance path and configured to rotate about an axis, a plurality of background members provided at the rotation member and configured to be positioned to face the reading unit when the rotation member rotates, and a first cleaning unit configured to clean the plurality of background members are included.

The present application is based on, and claims priority from JP Application Serial Number 2023-164715, filed Sep. 27, 2023, the disclosure of which is hereby incorporated by reference herein in its entirety.

### BACKGROUND

### 1. Technical Field

The present disclosure relates to an image reading device.

### 2. Related Art

An example of this type of device is described in JP-A-2009-290801. JP-A-2009-290801 discloses an image reading device including an image reading unit, a background body including a plurality of reading background surfaces, and a drive structure that rotates the background body.

The device described in JP-A-2009-290801 does not consider cleaning the background surface of the background body, and there is no description suggesting the cleaning.

### SUMMARY

To solve the above problem, an image reading device according to the present disclosure includes a reading unit configured to read an image of a medium conveyed in a conveyance direction in a conveyance path, a rotation member disposed to face the reading unit across the conveyance path and configured to rotate about an axis, a plurality of background members provided at the rotation member and configured to be positioned to face the reading unit when the rotation member rotates, and a first cleaning unit configured to clean the plurality of background members.

### BRIEF DESCRIPTION OF THE DRAWINGS

FIG. 1 is a schematic configuration diagram of a main part of an inside of an image reading device according to an embodiment as viewed from a side.

FIG. 2 is a side cross-sectional view of a main part of a first embodiment.

FIG. 3 is a perspective view of the main part of the first embodiment.

FIG. 4 is a side cross-sectional view of the main part of the first embodiment.

FIG. 5 is a side cross-sectional view of a main part of a second embodiment.

### DESCRIPTION OF EMBODIMENTS

First, the present disclosure is schematically described below.

An image reading device according to a first aspect of the present disclosure includes a reading unit configured to read an image of a medium conveyed in a conveyance direction in a conveyance path, a rotation member disposed to face the reading unit across the conveyance path and configured to rotate about an axis, a plurality of background members provided at the rotation member and configured to be positioned to face the reading unit when the rotation member rotates, and a first cleaning unit configured to clean the plurality of background members.

According to the present aspect, the image reading device includes a plurality of background members provided at the rotation member and configured to be positioned to face the reading unit when the rotation member rotates, and a first cleaning unit configured to clean the plurality of background members. This enables the first cleaning unit to easily clean the plurality of background members when the plurality of background members are contaminated. That is, without needing to be disassembled or the like, the image reading device can be cleaned by the first cleaning unit in a state of being attached with the plurality of background members having been contaminated.

A second aspect of the image reading device according to the present disclosure is an aspect dependent on the first aspect, the image reading device including a rotation drive unit configured to rotate the rotation member about an axis, a control unit, and a sensor configured to sense contamination of the plurality of background members, in which the first cleaning unit is disposed and configured to clean the plurality of background members in a state where the rotation member rotates, and the control unit performs a cleaning operation for the plurality of background members by the first cleaning unit based on acquired information by the sensor.

Here, “performing a cleaning operation for a background member” means continuously using the background member without cleaning it when the acquired information regarding a degree of contamination of the background member acquired by the sensor is in a state where cleaning is unnecessary, and conversely, performing a cleaning of the background member by the first cleaning unit when in a state where cleaning is necessary.

In addition, “state where cleaning is necessary” means a state where information regarding the degree of contamination of the background member sensed by the sensor is set as being not able to exhibit the performance required for the background member.

According to the present aspect, the first cleaning unit is disposed and configured to clean the plurality of background members in a state where the rotation member rotates, and the control unit performs a cleaning operation for the plurality of background members by the first cleaning unit based on acquired information by the sensor. This can automate and easily perform an operation of determining whether or not cleaning of the background member is necessary and performing a cleaning when the cleaning is necessary.

A third aspect of the image reading device according to the present disclosure is an aspect dependent on the second aspect, in which the reading unit also serves as the sensor.

According to the present aspect, since the reading unit also serves as the sensor, the degree of contamination of the background member can be sensed by utilizing existing constituent elements.

A fourth aspect of the image reading device according to the present disclosure is an aspect dependent on the second aspect, in which the plurality of background members include a set of background members of a same color, and the control unit performs a switching operation of the plurality of background members based on the acquired information by the sensor for the plurality of background members cleaned by the first cleaning unit.

Here, “performing a switching operation of the background member” means continuously using the background member when the acquired information regarding the degree of contamination of one of the plurality of background members acquired by the sensor is in a state where switching to another background member is unnecessary, and conversely, rotating the rotation member to switch to the other background member when in a state where switching is necessary.

In addition, “state where switching is necessary” means a state where information regarding the degree of contamination of the one of the plurality of background members after cleaning sensed by the sensor is set as being not able to exhibit the performance required for the background member.

According to the present aspect, the control unit performs a switching operation of the plurality of background members based on the acquired information by the sensor for the plurality of background members cleaned by the first cleaning unit. This can automate and easily perform an operation of determining whether or not switching of the background member to the other background member of the same color is necessary and switching to the other background member of the same color when the switching is necessary.

A fifth aspect of the image reading device according to the present disclosure is an aspect dependent on the second aspect, in which the first cleaning unit is disposed between one of the plurality of background members and another one of the plurality of background members on an outer peripheral surface of the rotation member.

Note that the present aspect can also be dependent on the third aspect or the fourth aspect.

According to the present aspect, the first cleaning unit is disposed between one of the plurality of background members and another one of the plurality of background members on an outer peripheral surface of the rotation member. This can easily clean the each of background members by rotating the rotation member.

A sixth aspect of the image reading device according to the present disclosure is an aspect dependent on the second aspect, in which the rotation member includes a reference member having a reference color disposed between the one of the plurality of background members and the other of the plurality of background members on an outer peripheral surface.

Note that the present aspect can also be dependent on any one of the third aspect to the fifth aspect.

According to the present aspect, the rotation member includes a reference member having a reference color disposed between the one of the plurality of background members and the other of the plurality of background members on an outer peripheral surface. This can determine in a short time the necessity of switching to any background member after acquiring shading correction data using the reference plate.

A seventh aspect of the image reading device according to the present disclosure is an aspect dependent on the sixth aspect, in which the reading unit includes a light-transmissive member disposed to face the rotation member, the rotation member includes a second cleaning unit configured to clean the light-transmissive member by rotating, and the control unit performs a cleaning operation for the light-transmissive member by the second cleaning unit based on information read by the reading unit in a state where the reference member faces the light-transmissive member.

Here, “performing a cleaning operation for a light-transmissive member” means continuously using the light-transmissive member without cleaning it when the information regarding the degree of contamination of the light-transmissive member read by the reading unit is in a state where cleaning is unnecessary, and conversely, the second cleaning unit performs a cleaning of the light-transmissive member when in a state where cleaning is necessary.

In addition, “state where cleaning is necessary” means a state where the degree of contamination of the light-transmissive member is set as being not able to exhibit the performance required for the light-transmissive member.

According to the present aspect, the control unit performs a cleaning operation for the light-transmissive member by the second cleaning unit based on information read by the reading unit in a state where the reference member faces the light-transmissive member. This can determine the degree of contamination of the light-transmissive member, perform a cleaning when the cleaning of the light-transmissive member is necessary, and then sense the degree of contamination of the background member. Therefore, the degree of contamination of the background member can be accurately acquired.

### EMBODIMENTS

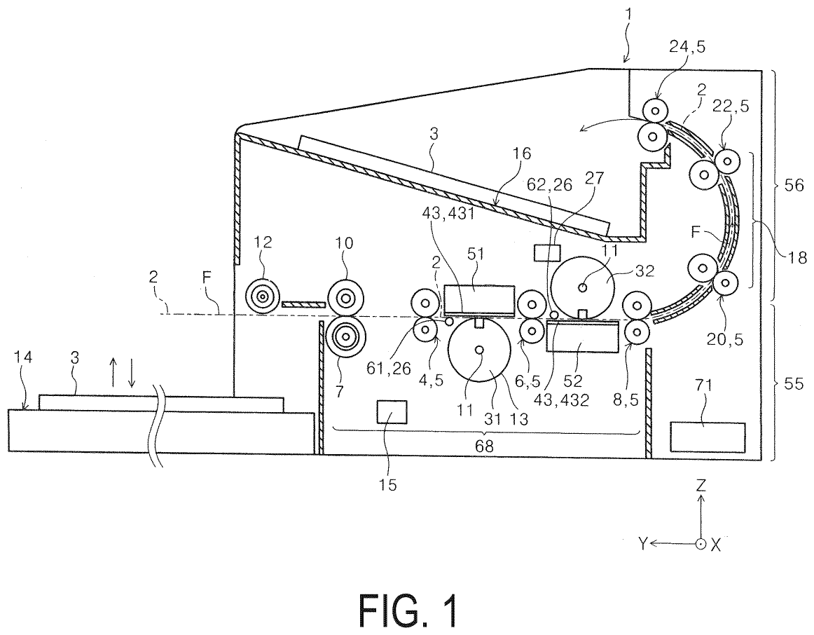

Hereinafter, embodiments of the image reading device according to the present disclosure will be specifically described with reference to FIGS. 1 to 5.

In the following description, three axes that are orthogonal to each other are referred to as an X axis, a Y axis, and a Z axis, respectively, as illustrated in each of the drawings. Directions indicated by arrows of the three axes (X, Y, and Z) are +directions of the respective directions, and opposite directions are −directions. The Z axis direction corresponds to a vertical direction, that is, a direction in which gravity acts, the +Z direction indicates a vertically upward direction, and the −Z direction indicates a vertically downward direction. The X axis direction and the Y axis direction correspond to horizontal directions. The +Y direction indicates a forward direction of the device, and the −Y direction indicates a rearward direction of the device. The +X direction indicates a rightward direction of the device, and the −X direction indicates a leftward direction of the device.

### Overall Structure of Image Reading Device

An image reading device 1 of the present embodiment is a scanner configured to read an image of a medium to be a document. Here, the image means one visually recorded on the medium, and is, for example, a character, a figure, a table, a picture, a photograph, or the like. The medium is not limited to a sheet, and also includes a card and a booklet. The image reading device 1 is not limited to a scanner, and may be a copier, a facsimile machine, or the like.

As illustrated in FIG. 1, the image reading device 1 includes two reading units, a first reading unit 51 and a second reading unit 52, as reading units configured to read an image on a medium 3. The image reading device further includes a first conveyance roller 4 configured to convey the medium 3 along a conveyance path 2 in a conveyance direction F and provided upstream of the first reading unit 51, a second conveyance roller 6 provided upstream of the second reading unit 52 positioned more downstream than the first reading unit 51, and a third conveyance roller 8 provided downstream of the second reading unit 52 in the conveyance direction F.

A roller pair of a feed roller 10 and a separation roller 7 are disposed upstream in the conveyance direction F of the first conveyance roller 4. The feed roller 10 is a drive roller configured to rotate by power of a first drive source 15, and conveys the medium 3 toward the conveyance direction F. The separation roller 7 is a drive roller configured to rotate by power of a drive source not illustrated, and is a roller configured to separate media from a plurality of the media 3 into one.

Here, the separation roller 7 rotates in a direction of sending the medium 3 to the upstream side (+Y direction) in the conveyance direction F by the power of the drive source. The separation roller 7 includes a torque limiter not illustrated, and when this torque limiter is applied with torque exceeding a set value, the separation roller 7 is driven to rotate in a direction of sending the medium 3 to the downstream side (−Y direction) in the conveyance direction F.

A pick roller 12 is disposed upstream of the separation roller 7. The pick roller 12 is a drive roller configured to rotate by the power of the first drive source 15 same as the feed roller 10, and sends the medium 3 toward the conveyance direction F. The first conveyance roller 4, the second conveyance roller 6, and the third conveyance roller 8 constituting a conveyance unit 5 configured to convey the medium 3 in the conveyance direction F also include drive rollers configured to rotate by the power of the first drive source 15.

As illustrated in FIG. 1, in the present embodiment, a curved reverse path 18 is provided downstream of a straight path 68 from the feed roller 10 to the third conveyance roller 8, that is, downstream of the third conveyance roller 8. At the curved reverse path 18, a fourth conveyance roller 20, a fifth conveyance roller 22, and a discharge roller 24 are arranged in this order along the conveyance direction F.

A discharge reception unit 16 that receives the medium 3 discharged from the curved reverse path 18 is disposed above the straight path 68 to achieve compactness.

In FIG. 1, reference sign 71 denotes a control unit. A control unit 71 controls drive of the first drive source 15 and drive of a second drive source 27 described later in accordance with conveyance of the medium 3. The first drive source 15 and the second drive source 27 are configured by motors.

The control unit 71 includes a CPU, a flash ROM, and a RAM. The CPU performs various arithmetic processing according to a program stored in the flash ROM, and controls the operation of the entire image reading device 1. The flash ROM serving as an example of a storage means is a readable and rewritable nonvolatile memory. The RAM serving as an example of a storage means temporarily stores a variety of information.

In FIG. 1, reference sign 14 denotes a medium placement unit for setting a medium 3 that is a reading target. The medium 3 on the medium placement unit 14 is conveyed through the conveyance path 2 and finally discharged to the discharge reception unit 16.

The medium placement unit 14 is configured to move up and down. When the medium 3 set on the medium placement unit 14 is sent in the conveyance direction F, first, power is transmitted from a drive source not illustrated to the medium placement unit 14 to be moved upward (+Z direction), and the uppermost one of the media 3 having been set is stopped in a state of being in contact with the pick roller 12. The pick roller 12 rotates in this state, whereby the medium 3 is sent in the conveyance direction F, and a tip end of the medium 3 reaches a nip position the roller pair of the feed roller 10 and the separation roller 7.

In a case of a multi-feed state where a plurality of sheets of media 3 are sent, they are separated by the separation roller 7 into one sheet, the one sheet is conveyed in the conveyance direction F by the first conveyance roller 4, and the first reading unit 51 reads an image of a first surface of the medium 3. Furthermore, the medium 3 having been read by the first reading unit 51 is conveyed by the second conveyance roller 6, and the second reading unit 52 reads an image on a second surface opposite to the first surface of the medium 3.

The medium 3 having been read by the second reading unit 52 is sent to the curved reverse path 18 by the third conveyance roller 8, conveyed by the fourth conveyance roller 20 and the fifth conveyance roller 22, and discharged to the discharge reception unit 16 by the discharge roller 24.

As illustrated in FIG. 1, in the present embodiment, the first reading unit 51 and the second reading unit 52 configured to read an image of the medium 3 conveyed in the conveyance direction F include a first light-transmissive member 431 and a second light-transmissive member 432, which are light-transmissive members 43 disposed between the first reading unit 51 and the second reading unit 52 and the conveyance path 2.

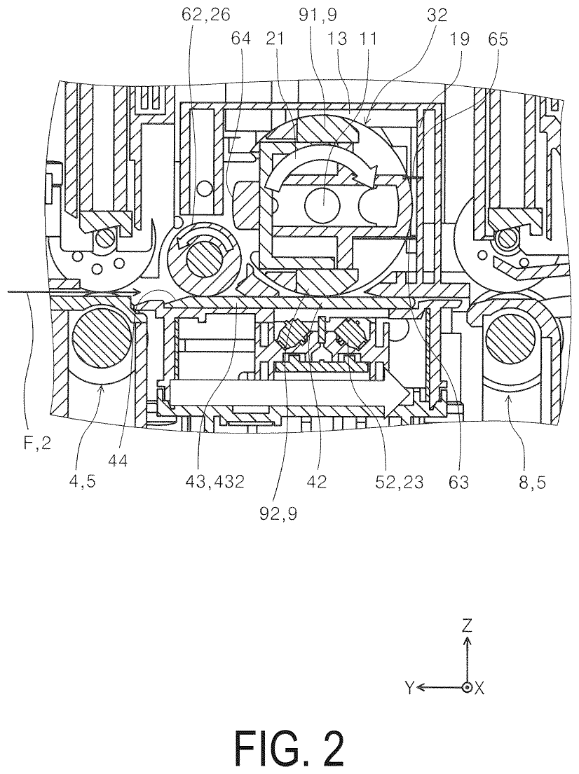

In FIG. 2, reference sign 42 denotes a reading position of the second reading unit 52, and reference sign 44 denotes an inclination surface. The inclination surface 44 is provided at an upstream end part on a reading surface side of the light-transmissive member 43, and guides the medium 3 move in the direction along the conveyance path 2 when the tip end of the medium 3 being conveyed comes in contact with the inclination surface.

### Rotation Member

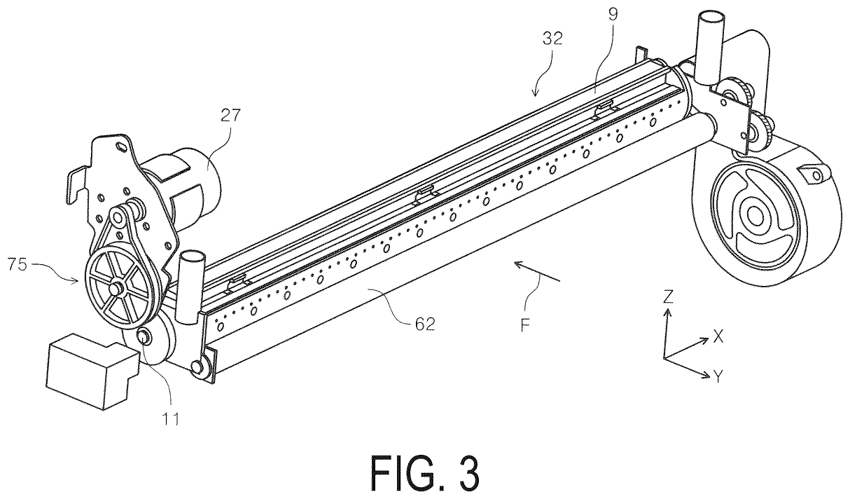

As illustrated in FIG. 1, a first rotation member 31 and a second rotation member 32 as rotation members are arranged on the opposite sides to the first reading unit 51 and the second reading unit 52 of the first light-transmissive member 431 and the second light-transmissive member 432. The first rotation member 31 and the second rotation member 32 are rotation members disposed to face the first reading unit 51 and the second reading unit 52 and configured to rotate about a shaft 11. The first rotation member 31 and the second rotation member 32 have a substantially cylindrical shape (FIG. 3) and are formed to have a length covering a reading range (X axis direction) of the first reading unit 51 and the second reading unit 52.

As illustrated in FIG. 2, in the present embodiment, the first rotation member 31 and the second rotation member 32 include a plurality of background members 9, 9, . . . and a second cleaning unit 63. Furthermore, a first cleaning unit 65 configured to clean the background members 9, 9, . . . is included. The plurality of background members 9, 9, . . . , the second cleaning unit 63, and the first cleaning unit 65 will be described later. Note that since FIG. 2 is an enlarged view of a part of the second reading unit 52, the first rotation member 31 is not visible.

As illustrated in FIG. 3, the first rotation member 31 and the second rotation member 32 rotate about the shaft 11 by power of the second drive source 27, which is a common drive source. The rotational operation of the first rotation member 31 and the second rotation member 32 is controlled by the control unit 71. In FIG. 3, reference sign 75 denotes a power transmission mechanism. The second drive source 27 transmits power to, and rotates, the first rotation member 31 and the second rotation member 32 via the power transmission mechanism 75.

Note that the first rotation member 31 and the second rotation member 32 may be configured to rotate not by the common second drive source 27 but by power of individual motors.

The first reading unit 51, the first light-transmissive member 431, and the second rotation member 32 are arranged above the conveyance path 2. The second reading unit 52, the second light-transmissive member 432, and the first rotation member 31 are arranged below the conveyance path 2.

As illustrated in FIG. 1, in the present embodiment, the image reading device 1 includes a lower unit 55 and an upper unit 56. The upper unit 56 is configured to pivot in an up-down direction and open with respect to the lower unit 55 by an open/close mechanism not illustrated.

The lower unit 55 includes the second reading unit 52, the second light-transmissive member 432, and the first rotation member 31. The upper unit 56 includes the first reading unit 51, the first light-transmissive member 431, and the second rotation member 32. In a state where the upper unit 56 is closed with respect to the lower unit 55, as illustrated in FIG. 1, the second light-transmissive member 432 and the second rotation member 32 are arranged to face each other, and the first light-transmissive member 431 and the first rotation member 31 are arranged to face each other.

In a state where the upper unit 56 is opened with respect to the lower unit 55, although not illustrated, the second light-transmissive member 432 and the second rotation member 32 do not face each other, and the first light-transmissive member 431 and the first rotation member 31 do not face each other. That is, the facing surfaces of lower unit 55 and upper unit 56 are brought into an exposed state, and the user can access.

As illustrated in FIGS. 1 and 2, in the present embodiment, a first conveyance assist unit 61 and a second conveyance assist unit 62 are included as conveyance assist units facing the first light-transmissive member 431 and the second light-transmissive member 432, disposed upstream of the first rotation member 31 and the second rotation member 32, and configured to assist conveyance of the medium 3. Here, the first conveyance assist unit 61 and the second conveyance assist unit 62 include a drive roller 26 called a platen roller 26 configured to rotate with transmitted power of the first drive source 15.

### First Embodiment

Following the description of the overall structure of the image reading device 1 described above, the image reading device 1 of the first embodiment will be described below with part thereof being overlapped.

As illustrated in FIGS. 1 and 2, the image reading device 1 of the first embodiment includes, as described above, the two reading units of the first reading unit 51 and the second reading unit 52 as the reading units configured to read the image of the medium 3 conveyed in the conveyance direction F through the conveyance path 2. As mentioned above, since FIG. 2 is an enlarged view of a part of the second reading unit 52, the first reading unit 51 does not appear in the drawing. However, the structure of the first reading unit 51 is the same as the structure of the second reading unit 52 except being upside down (FIG. 1). Therefore, they will be collectively described below.

The two rotation members, the first rotation member 31 and the second rotation member 32, are arranged as rotation members to face the first reading unit 51 and the second reading unit 52 across the conveyance path 2. The first rotation member 31 and the second rotation member 32 are configured to rotate about the shaft 11.

As illustrated in FIG. 2, the first rotation member 31 and the second rotation member 32 are provided with a plurality of, specifically, two background members 9 and 9. The background members 9 come in types such as white, black, and gray, and which to use is determined according to design specifications of the image reading device 1. As illustrated in FIG. 3, the background member 9 has substantially the same length in the X axis direction as the first rotation member 31 and the second rotation member 32. Here, a background member 91 in white and a background member 92 in black are respectively provided as the background members 9 and 9. When the first reading unit 51 and the second reading unit 52 read an image of the medium 3, the first rotation member 31 and the second rotation member 32 are rotated to position the background member 91 or the background member 92 to face the first light-transmissive member 431 and the second light-transmissive member 432, respectively. Note that the two of the background members 9 may be in white or the two of the background members 9 may be in black.

Furthermore, as illustrated in FIG. 2, in the present embodiment, the first cleaning unit 65 configured to clean the two background members 9 and 9, that is, the background member 91 and the background member 92 is included. Here, the first cleaning unit 65 is a brush whose base end is fixed to a frame 19, which is a structural member of the upper unit 56. The first cleaning unit 65 is not limited to the brush, and may be one configured to clean a surface of the background member 9 required for a function as a background member, and for example, may be one having a structure in which cleaning is performed by blowing an air flow.

Furthermore, as illustrated in FIGS. 1, 2, and 3, in the present embodiment, the second drive source 27 as a rotation drive unit configured to rotate the first rotation member 31 and the second rotation member 32 about the shaft 11, the control unit 71, and a sensor 23 configured to sense the degree of contamination of the background member 91 and the background member 92 as the background members 9 are included.

In the present embodiment, the first reading unit 51 and the second reading unit 52, which are reading units, serve as the sensor 23. That is, an optical system of a light emitting unit and a light receiving unit configured to read the image of the medium 3 of the first reading unit 51 and the second reading unit 52 is configured to be used as the sensor 23. The first rotation member 31 and the second rotation member 32 rotate power transmitted from the second drive source 27 via the power transmission mechanism 75.

The first cleaning unit 65 is disposed configured to clean the background member 91 and the background member 92 in a state where the first rotation member 31 and the second rotation member 32 rotate.

The control unit 71 performs a cleaning operation for the background member 9 by the first cleaning unit 65 based on the acquired information by the sensor 23.

Here, “performing a cleaning operation for the background member 9” means continuously using the background member 9 without cleaning one or both of the background members 9 not requiring a cleaning when the acquired information regarding a degree of contamination of the background member 9 acquired by the sensor 23 is in a state where cleaning is unnecessary, and conversely, the first cleaning unit 65 performs a cleaning of one or both of the background members 9 requiring a cleaning when in a state where cleaning is necessary. This cleaning operation is performed by the control unit 71.

In addition, “state where cleaning is necessary” means a state where information regarding the degree of contamination of the background member 9 sensed by the sensor 23 is set as being not able to exhibit the performance required for the background member 9. A value of information corresponding to this “state where cleaning is necessary” is set in advance.

As illustrated in FIG. 2, in the present embodiment, the first cleaning unit 65 is disposed between the background member 91 and the background member 92 on an outer peripheral surface 13 of the first rotation member 31 and the second rotation member 32.

Furthermore, in the first rotation member 31 and the second rotation member 32, a reference member 64 having a reference color is disposed between the background member 91 and the background member 92 on the outer peripheral surface 13. Here, the reference color of the reference member 64 is white. The reference member 64 is provided and thus the first reading unit 51 and the second reading unit 52 acquire shading correction data from the reference member 64 and correct linearity of an image signal using the data.

As illustrated in FIG. 2, in the present embodiment, the first rotation member 31 and the second rotation member 32 include the second cleaning unit 63 configured to clean the light-transmissive member 43 by rotating.

The second cleaning unit 63 is a brush whose base end is fixed to the first rotation member 31 and the second rotation member 32. The second cleaning unit 63 is not limited to the brush, and may be one configured to clean a surface of the light-transmissive member 43 required for a function as a light-transmissive member, and for example, may have a structure in which cleaning is performed by blowing an air flow.

Although the first rotation member 31 is also attached with the second cleaning unit 63, it has the same structure as that of the second cleaning unit 63 of the second rotation member 32, and thus, is not illustrated. The second cleaning unit 63 comes into contact with, and cleans, the first light-transmissive member 431 and the second light-transmissive member 432 by rotation of the first rotation member 31 and the second rotation member 32 in a direction of arrow 21 about the shaft 11 as a rotation center.

Note that the second cleaning unit 63 is not limited to be at the position illustrated in FIG. 2, and may be at any position as long as the second cleaning unit 63 can come into contact with, and clean, the first light-transmissive member 431 and the second light-transmissive member 432 by rotation of the first rotation member 31 and the second rotation member 32. The contact angle of the second cleaning unit 63 with the light-transmissive member 43 is not necessarily the right angle as illustrated in FIG. 2, and may be inclined.

The control unit 71 is configured to perform the cleaning operation for the light-transmissive member 43 by the second cleaning unit 63 based on the information read by the first reading unit 51 and the second reading unit 52 in a state where the reference member 64 faces the light-transmissive member 43 by rotating the first rotation member 31 and the second rotation member 32.

Here, “performing a cleaning operation for the light-transmissive member 43” means continuously using the light-transmissive member 43 without cleaning it when the information regarding the degree of contamination of the light-transmissive member 43 read by the first reading unit 51 and the second reading unit 52 is in a state where cleaning is unnecessary, and conversely, the second cleaning unit 63 performs a cleaning of the light-transmissive member 43 when in a state where cleaning is necessary. This cleaning operation is performed by the control unit 71.

In addition, “state where cleaning is necessary” means a state where the degree of contamination of the light-transmissive member 43 is set as being not able to exhibit the performance required for the light-transmissive member 43.

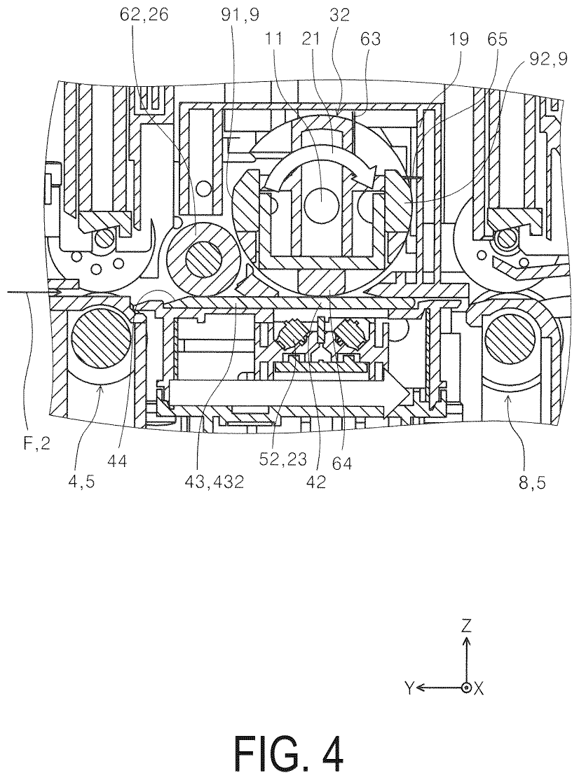

As illustrated in FIG. 4, it is possible to determine whether or not a cleaning of the light-transmissive member 43 is necessary from the information read by the first reading unit 51 and the second reading unit 52 in a state where the reference member 64 faces the light-transmissive member 43. For example, an RGB value can be used as the information for the determination. With RGB value acquired when the light-transmissive member 43 is not contaminated as a reference value, the value of the information is set in advance and the determination can be made depending on the degree of deviation from the reference value.

### Flow of Cleaning Operation for Background Member by First Cleaning Unit

The control unit 71 performs the cleaning operation for the background member 9 by the first cleaning unit 65 in the following flow.

(1) Acquire information by causing the first reading unit 51 and the second reading unit 52 to read the information in a state where the reference member 64 faces the light-transmissive member 43.

(2) Determine whether or not cleaning of the light-transmissive member 43 is necessary from the information acquired in (1).

(2-1) When it is determined that cleaning of the light-transmissive member 43 is unnecessary, cause the first reading unit 51 and the second reading unit 52 as the sensors 23 to perform sensing in a state where one background member 92 faces the light-transmissive member 43.

(2-2) When cleaning of the light-transmissive member 43 is necessary, perform cleaning of the light-transmissive member 43 by the second cleaning unit 63. After performing the predetermined cleaning, cause the first reading unit 51 and the second reading unit 52 to read information again to acquire the information, and return to the determination of (2).

(3) Determine whether or not cleaning of the background member 92 is necessary from the acquired information by sensing of (2-1).

(3-1) When cleaning of the background member 92 is unnecessary, continuously use without cleaning the background member 92, and convey the medium to perform reading of the image.

(3-2) When cleaning of the background member 92 is necessary, clean the background member 92 by the first cleaning unit 65. After performing the predetermined cleaning, acquire information again by the sensing, and return to the determination of (3).

Note that when the number of times of returning to the determination of (2) exceeds a predetermined number of times in (2-2), it is desirable to notify the user of the state. When the number of times of returning to the determination of (3) exceeds a predetermined number of times in (3-2), it is desirable to notify the user of the state.

The timing of starting the flow of the cleaning operation for the background members by the first cleaning unit may be set to any timing such as when the power of the image reading device is on, when the number of sheets to read of the medium exceeds a predetermined number of sheets every predetermined use time elapses, or when the user determines that it is necessary. Alternatively, a plurality of them may be set to be possible.

### Explanations of Effects of First Embodiment

(1) In the present embodiment, the plurality of background members 9 provided in the first rotation member 31 and the second rotation member 32, which are rotation members, and configured to be positioned to face the first reading unit 51 and the second reading unit 52, which are reading units, when the first rotation member 31 and the second rotation member 32 rotate, and the first cleaning unit 65 configured to clean the plurality of background members 9 are included. This enables the first cleaning unit 65 to easily clean the plurality of background members 9 when the plurality of background members are contaminated. That is, without needing to be disassembled or the like, the image reading device 1 can be cleaned by the first cleaning unit 65 in a state of being attached with the plurality of background members 9 having been contaminated.

(2) In the present embodiment, the first cleaning unit 65 is disposed and configured to clean the plurality of background members 9 in a state where the first rotation member 31 and the second rotation member 32, which are rotation members, rotate, and the control unit 71 performs a cleaning operation for the plurality of background members 9 by the first cleaning unit 65 based on acquired information by the sensor 23. This can automate and easily perform an operation of determining whether or not cleaning of the background member 9 is necessary and performing a cleaning when the cleaning is necessary.

(3) In the present embodiment, since the first reading unit 51 and the second reading unit 52, which are reading units, serve as the sensor 23, the degree of contamination of the background members 9 can be sensed by utilizing existing constituent elements.

(4) In the present embodiment, the first cleaning unit 65 is disposed between one background member 91 and the other background member 92 on the outer peripheral surface of the first rotation member 31 and the second rotation member 32 which are rotation members. This can easily clean the each of background members 9 by rotating the first rotation member 31 and the second rotation member 32.

(5) In the present embodiment, the first rotation member 31 and the second rotation member 32 include the reference member 64 having a reference color disposed between one background member 91 and the other background member 92 on the outer peripheral surface 13. This can determine in a short time the necessity of switching to any background member after acquiring shading correction data using the reference member 64.

(6) In the present embodiment, the control unit 71 performs the cleaning operation for the light-transmissive member 43 by the second cleaning unit 63 based on the information read by the first reading unit 51 and the second reading unit 52 in a state where the reference member 64 faces the light-transmissive member 43. This can determine the degree of contamination of the light-transmissive member 43, perform a cleaning when the cleaning of the light-transmissive member 43 is necessary, and then sense the degree of contamination of the background member 9. Therefore, the degree of contamination of the background member 9 can be accurately acquired.

### Second Embodiment

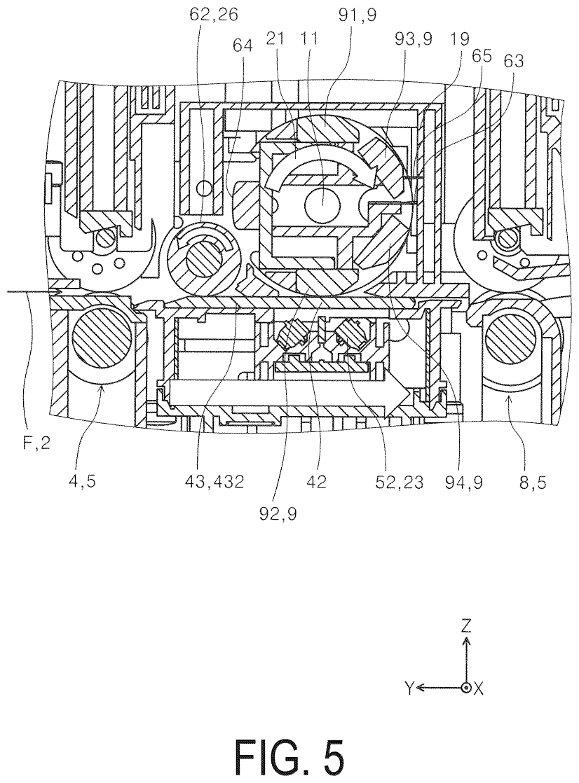

Next, the image reading device 1 according to the second embodiment will be described with reference to FIG. 5. The same parts as those in the first embodiment are denoted by the same reference signs, and the description of the configurations and corresponding effects will be omitted. As illustrated in FIG. 5, in the present embodiment, the first rotation member 31 and the second rotation member 32 are provided with four background members 91, 92, 93, and 94 as the plurality of background members 9. The background members 91, 92, 93, and 94 come in types such as white, black, and gray, and which to use is determined according to design specifications of the image reading device 1. Here, the background member 91 and the background member 93 are in white, and the background member 92 and the background member 94 are in black. Of course, it is not limited to this color combination. The second cleaning unit 63 is configured to be positioned between the background member 93 and the background member 94.

In the image reading device 1 according to the second embodiment, the flow of the cleaning operation for the background member 9 by the first cleaning unit 65 is similar to that of the first embodiment.

### Third Embodiment

Next, the image reading device 1 according to a third embodiment will be described with reference to FIG. 2. The same parts as those in the first embodiment are denoted by the same reference signs, and the description of the configurations and corresponding effects will be omitted. However, the color points of the background member 91 and the background member 92 are different from those in Example 1 as described later.

In the third embodiment, the two background members 9 and 9 have a set of background members of the same color. Specifically, the background member 91 and the background member 92 are made of the same white or the same black. The control unit 71 is configured to perform the switching operation of the background member 9 based on the acquired information by the sensor 23 for the background member 9 cleaned by the first cleaning unit 65.

Here, “performing a switching operation of the background member 9” means continuously using the background member 92 when the acquired information regarding the degree of contamination of, for example, one of the plurality of background members 92 acquired by the sensor 23 is in a state where switching to the other background member 91 is unnecessary, and conversely, rotating the first rotation member 31 and the second rotation member 32 to switch to the other background member 91 when in a state where switching is necessary.

In addition, “state where switching is necessary” means a state where information regarding the degree of contamination of the one of the plurality of background members after cleaning sensed by the sensor 23 is set as being not able to exhibit the performance required for the background member 92.

### Flow of Cleaning Operation and Switching Operation for Background Member by First Cleaning Unit

The control unit 71 performs the cleaning operation and the switching operation for the background member 9 by the first cleaning unit 65 in the following flow.

(1) Acquire information by causing the first reading unit 51 and the second reading unit 52 to read the information in a state where the reference member 64 faces the light-transmissive member 43.

(2) Determine whether or not cleaning of the light-transmissive member 43 is necessary from the information acquired in (1).

(2-1) When it is determined that cleaning of the light-transmissive member 43 is unnecessary, cause the first reading unit 51 and the second reading unit 52 as the sensors 23 to perform sensing in a state where the background member 92 faces the light-transmissive member 43.

(2-2) When cleaning of the light-transmissive member 43 is necessary, perform cleaning of the light-transmissive member 43 by the second cleaning unit 63. After performing the predetermined cleaning, cause the first reading unit 51 and the second reading unit 52 to read information again to acquire the information, and return to the determination of (2).

(3) Determine whether or not cleaning of the background member 92 is necessary from the acquired information by sensing of (2-1).

(3-1) When cleaning of the background member 92 is unnecessary, continuously use without cleaning the background member 92, and convey the medium to perform reading of the image.

(3-2) When cleaning of the background member 92 is necessary, clean the background member 92 by the first cleaning unit 65. After performing the predetermined cleaning, acquire information again by the sensing, and determine whether or not cleaning of the background member 92 is necessary from the acquired information.

(3-2-1) When cleaning of the background member 92 is unnecessary, continuously use without cleaning the background member 9, and convey the medium to perform reading of the image.

(3-2-2) When cleaning of the background member 92 is necessary, switch the background member 92 to the other background member 91, and convey the medium to perform reading of the image.

Note that the information may be acquired by the sensing after the first cleaning unit 65 performs the second cleaning for the background member 92, whether or not the cleaning of the background member 92 is necessary may be determined from the acquired information, and when the cleaning of the background member 92 is still necessary, the background member 92 may be switched to the other background member 91.

The cleaning operation and the switching operation described above are the same also for the configuration provided with the four background members 91, 92, 93, and 94 illustrated in the second embodiment (FIG. 5). For example, when it is determined switching to the background member 92 in black is necessary in the state of FIG. 5, the background member 92 is switched to the other background member 94 in the same black.

According to the present embodiment, the control unit 71 performs the switching operation of the background member 9 based on the acquired information by the sensor 23 for the background member 9 cleaned by the first cleaning unit 65. This can automate and easily perform an operation of determining whether or not switching of the background member 9 to the other background member 9 of the same color is necessary and switching to the other background member 9 of the same color when the switching is necessary.

### OTHER EMBODIMENTS

The image reading device 1 according to the present disclosure is based on the configuration of the embodiments described above, but it is of course possible to change or omit a partial configuration within the scope not departing from the gist of the present disclosure.

In the above embodiments, the image reading device including the first reading unit 51 and the second reading unit 52 as the reading units and configured to read both the first surface and the second surface of the medium 3 has been described, but the present disclosure can also be applied to an image reading device having a one-side reading structure.

In the above embodiments, the image reading device 1 including the straight path 68 and the curved reverse path 18 in the conveyance path 2 has been described, but the present disclosure is also applicable to a device not including the curved reverse path 18.

In the first embodiment, a case of the structure provided with the light-transmissive member 43 has been described, but a structure in which the light-transmissive member 43 is omitted can be adopted.

In the first embodiment, a structure in which the first rotation member 31 and the second rotation member 32 are rotated by the second drive source 27 as the rotation drive unit has been described, but a structure in which they are manually rotated without depending on the drive source may be adopted.

What is claimed is:

1. An image reading device, comprising:
a reading unit configured to read an image of a medium conveyed in a conveyance direction in a conveyance path;
a rotation member disposed to face the reading unit across the conveyance path and configured to rotate about an axis;
a plurality of background members provided at the rotation member and configured to be positioned to face the reading unit when the rotation member rotates; and
a first cleaning unit configured to clean the plurality of background members.

2. The image reading device according to claim 1, comprising:
a rotation drive unit configured to rotate the rotation member about an axis;
a control unit; and
a sensor configured to sense contamination of the plurality of background members, wherein
the first cleaning unit is disposed and configured to clean the plurality of background members in a state where the rotation member rotates, and
the control unit performs a cleaning operation for the plurality of background members by the first cleaning unit based on acquired information by the sensor.

3. The image reading device according to claim 2, wherein
the reading unit also serves as the sensor.

4. The image reading device according to claim 2, wherein
the plurality of background members include a set of background members of a same color, and
the control unit performs a switching operation of the plurality of background members based on the acquired information by the sensor for the plurality of background members cleaned by the first cleaning unit.

5. The image reading device according to claim 2, wherein
the first cleaning unit is disposed between one of the plurality of background members and another one of the plurality of background members on an outer peripheral surface of the rotation member.

6. The image reading device according to claim 2, wherein
the rotation member includes a reference member having a reference color disposed between the one of the plurality of background members and the other one of the plurality of background members on an outer peripheral surface.

7. The image reading device according to claim 6, wherein
the reading unit includes a light-transmissive member disposed to face the rotation member,
the rotation member includes a second cleaning unit configured to clean the light-transmissive member by rotating, and
the control unit performs a cleaning operation for the light-transmissive member by the second cleaning unit based on information read by the reading unit in a state where the reference member faces the light-transmissive member.
